(19) United States
(12) Patent Application Publication
(10) Pub. No.: US 2014/0206330 A1
(43) Pub. Date: Jul. 24, 2014

(54) MEASUREMENT REPORTING

(71) Applicant: Broadcom Corporation, Irvine, CA (US)

(72) Inventors: Tao CHEN, Espoo (FI); Arto Johannes LEHTI, Oulu (FI); Keiichi KUBOTA, Weybridge (GB); Christopher CALLENDER, Cleish (GB)

(73) Assignee: Broadcom Corporation, Irvine, CA (US)

(21) Appl. No.: 14/159,922

(22) Filed: Jan. 21, 2014

(30) Foreign Application Priority Data
Jan. 18, 2013 (GB) 1300925.3

(51) Int. Cl. H04W 24/10

(52) U.S. Cl. CPC H04W 24/10
USPC 455/418

(57) ABSTRACT

Measures for use in measurement reporting in a cellular telecommunications network. One or more configuration parameters for configuring a plurality of Cell Individual Offset (CIO) values for use in measurement reporting in a given cell are generated. Signalling information comprising the generated configuration parameters for the plurality of CIO values is transmitted to at least one user equipment in the given cell.

### TECHNICAL FIELD

The present invention relates to measurement reporting. In particular, but not exclusively, the present invention relates to measurement reporting in a cellular telecommunications network.

### BACKGROUND

Continuing expansion of mobile and other wireless communications is rendering the available radio spectrum more crowded and this trend is expected to increase in the near term as greater volumes of data are wirelessly exchanged. One recent approach to increase the ability of network operators to handle this increased traffic is to deploy so-called heterogeneous networks (or “HetNets”). In a heterogeneous network, there is at least one conventional cell, commonly termed a macro cell or the like, and one or more smaller cells, sometimes termed micro, pico or femto or local cells or the like, which are (fully or partially) within the coverage area of the macro cell(s) and which operate with various levels of coordination with the macro cell(s). The smaller cell or cells can be used for example to extend the coverage area of the macro cell(s), either to extend range or to fill holes in coverage provided by the macro cell(s), and to improve capacity.

In a heterogeneous network or HetNet, a macro cell network node (which may for example be a base station of the macro cell) typically transmits with a much higher power than the network node(s) of the smaller cell(s), and so the macro cell coverage area is much larger than that of the smaller cell(s). Some HetNet deployments have the macro cell(s) and the smaller cell(s) on different frequency bands, such as a primary versus a secondary component carrier, whereas others have the one or more smaller cells operating on the same frequency band as the macro cell. The latter deployment where the frequency band is shared is sometimes referred to as a “co-channel HetNet” or similar.

In the Third Generation Partnership Project (3GPP) document R1-110687 entitled “Interference Issues in Heterogeneous Networks for HSPA” by Qualcomm Inc. (3GPP TSG WG1 Meeting #64; Taipei, Taiwan; 21-25 Feb. 2011), there is a discussion of some of the issues concerning co-channel HetNets. HSPA in the title refers to the High Speed Packet Access radio access technology which is a 3G enhancement, but the issues identified there are in general applicable to other radio access technologies, such as for example the Long Term Evolution (LTE) of the Evolved Universal Terrestrial Radio Access Network (EUTRAN) technology. Introduction of the low power node(s) of the small cell(s) to the macro cell brings challenges in terms of reliability of the uplink (UL) control channel as well as interference management between the low power node(s) of the small cell(s) and the high power node or nodes of the macro cell. More specifically, an UL imbalance caused by the transmit power difference between the small and macro cell there is discussed, which can cause unreliable UL control channel decoding in the serving cell when the serving cell is the macro cell (the control channel specifically being the high speed dedicated physical control channel (HS-DPCCH) in this document R1-110687); there can be excessive UL interference from the macro cell to the low power small cell; and there can be excessive UL interference in the other direction from the small cell to the macro cell.

More generally, there may be an uplink (UL) and/or a downlink (DL) imbalance in a HetNet arising from the transmit power difference between the low power network nodes of the small cell(s) and the high power network node(s) of the macro cell, which can give rise to various problems.

### SUMMARY

According to a first aspect of the present invention, there is provided a method for use in measurement reporting in a cellular telecommunications network, the method comprising:

generating one or more configuration parameters for configuring a plurality of Cell Individual Offset (CIO) values for use in measurement reporting in a given cell; and

transmitting, to at least one user equipment in the given cell, signalling information comprising the generated configuration parameters for the plurality of CIO values.

According to a second aspect of the present invention, there is provided apparatus for use in measurement reporting in a cellular telecommunications network, the apparatus comprising a processing system configured to:

generate one or more configuration parameters for configuring a plurality of Cell Individual Offset (CIO) values for use in measurement reporting in a given cell; and

transmit, to at least one user equipment in the given cell, signalling information comprising the generated configuration parameters for the plurality of CIO values.

According to a third aspect of the present invention, there is provided a method for use in measurement reporting in a cellular telecommunications network, the method comprising, at a user equipment in a given cell:

receiving signalling information comprising one or more configuration parameters for configuring a plurality of Cell Individual Offset (CIO) values for use in measurement reporting in the given cell, the configuration parameters having been generated in and received from the network.

According to a fourth aspect of the present invention, there is provided apparatus for use in measurement reporting in a cellular telecommunications network, the apparatus comprising a processing system configured to cause a user equipment in a given cell to:

receive signalling information comprising one or more configuration parameters for configuring a plurality of Cell Individual Offset (CIO) values for use in measurement reporting in the given cell, the configuration parameters having been generated in and received from the network.

According to a fifth aspect of the present invention, there is provided a computer program product comprising a set of instructions which, when executed by a computerised device, is arranged to cause the device to carry out a method according to the first or third aspects of the present invention.

According to a sixth aspect of the present invention, there is provided a method for use in measurement reporting in a cellular telecommunications network, the method comprising:

transmitting, to at least one user equipment in a given cell, a measurement control message comprising one or more reporting criteria to be used by the at least one user equipment in relation to triggering transmittal of a measurement report into the network,

wherein the one or more reporting criteria comprise an indication of which Cell Individual Offset (CIO) value of a plurality of CIO values should be used by the at least one user equipment in relation to triggering transmittal of the measurement report.

According to a seventh aspect of the present invention, there is provided a method for use in measurement reporting in a cellular telecommunications network, the method comprising:

receiving a measurement report from at least one user equipment in a given cell,

wherein the received measurement report comprises an indication of which Cell Individual Offset (CIO) value of a plurality of CIO values caused triggering of transmittal of the measurement report from the at least one user equipment.

According to an eighth aspect of the present invention, there is provided a method for use in measurement reporting in a cellular telecommunications network, the method comprising, at a user equipment in a given cell:

receiving a measurement control message comprising one or more reporting criteria to be used by the user equipment in relation to triggering transmittal of a measurement report into the network,

wherein the one or more reporting criteria comprise an indication of which Cell Individual Offset (CIO) value of a plurality of CIO values should be used by the user equipment in relation to triggering transmittal of the measurement report.

According to a ninth aspect of the present invention, there is provided a method for use in measurement reporting in a cellular telecommunications network, the method comprising, at a user equipment in a given cell:

transmitting a measurement report into the network,

wherein the transmitted measurement report comprises an indication of which Cell Individual Offset (CIO) value of a plurality of CIO values caused triggering of transmittal of the measurement report from the user equipment.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1 shows schematically an example of a cellular telecommunications network according to embodiments;

FIG. 2 shows schematically an example of a cellular telecommunications network according to embodiments;

FIG. 3 shows a flow diagram according to embodiments; and

FIG. 4 shows a simplified block diagram of various devices which are example electronic devices suitable for use in practising embodiments.

### DETAILED DESCRIPTION

In the following, examples of embodiments of the present invention are described with reference to the drawings. For illustrating the present invention, the examples will be described in connection with a cellular communication network based on a 3GPP-type cellular system, such as Universal Mobile Telecommunication System (UMTS). However, it is to be noted that the present invention is not limited to an application using such types of communication system, but is also applicable in other types of communication systems such as EUTRAN and the like.

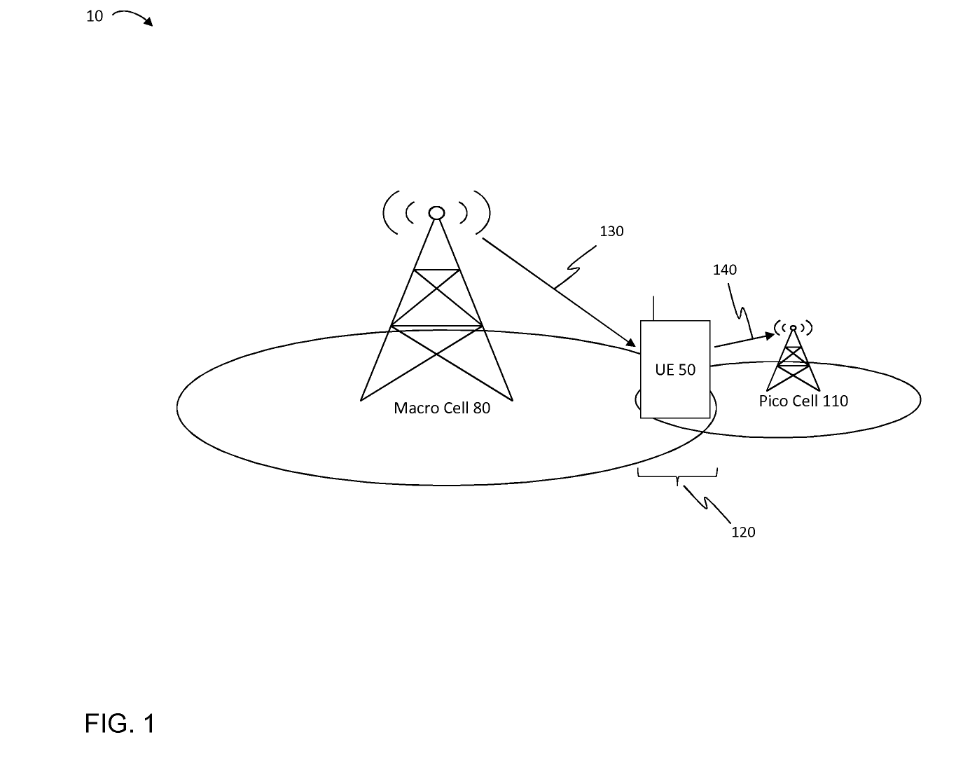

A basic system architecture of a communication network where examples of embodiments are practised may comprise a commonly known architecture of one or more communication networks comprising a wired or wireless access network subsystem and a core network. An example of a cellular telecommunications network 10 according to embodiments will now be described with reference to FIG. 1. In these embodiments, cellular telecommunication network 10 comprises a serving cell 80 that is currently serving a UE 50, one or more neighbouring cells that are neighbours of the serving cell 80 and a radio network controller (RNC) (not shown). Serving cell 80 comprises a base station for serving user equipment within its radio coverage area and in this example comprises a macro cell. The one or more neighbouring cells 110 also comprise base stations or other network nodes for serving user equipment within their radio coverage area and in this example comprise a pico cell 110, but could equally comprise multiple pico cells and/or one or more micro or femto cells or another macro cell.

In this example, cellular telecommunications network 10 comprises a heterogeneous network in which serving call 80 comprises a relatively high power base station or other network node and the neighbour cell 110 comprises a relatively low power base station or other network node with uplink and/or downlink coverage at least partially overlapping 120 with the macro cell. In these embodiments, serving cell 80 comprises a macro cell 80 and neighbour cell 110 comprises a pico cell 110.

User equipment 50 or another wireless transmit/receive device having a similar function, such as a modem chipset, a chip, a module etc., which can also be part of a user equipment or attached as a separate element to a user equipment, or the like, is able to communicate with the serving cell 80 or neighbour cell 110 via one or more wireless (or ‘radio’) communication channels for transmitting several types of data.

Cellular telecommunications network 10 may additionally be in communication with various mobility management entities (MMEs) (not shown), which facilitate mobility of user equipments across various carriers, and/or network management entities, which manage resources of the communication network 10, for example a radio network controller.

The general functions and interconnections of the described elements, which also depend on the actual network type, are known to those skilled in the art and described in corresponding specifications, so that a detailed description thereof is omitted herein. However, it is to be noted that several additional network elements and signalling links may be employed for a communication connection to or from user equipments, cells, RNCs serving gateways (S-GWs), packet data network gateways (P-GWs), besides those described in detail herein below.

In order to increase the peak data rates per user and make better use of the available network resources, it has for example been proposed to use two or more carriers (in the downlink direction or uplink direction or both) and/or two or more frequencies or bands (again, in the downlink direction or uplink direction or both) and/or two or more data flows (again, in the downlink direction or uplink direction or both). For example, high speed downlink packet access (HSDPA) multiflow (or ‘multipoint’) data transmission was introduced in 3GPP Release 11 (RP-111375) where multiple serving high speed downlink shared channel (HS-DSCH) cells serve packet data to a UE simultaneously. It has also been suggested that HSDPA multiflow operation is introduced over more than one carrier frequency. In multiflow, multiple simultaneous data streams are sent to improve coverage and spectrum usage, and to increase the peak data rates available.

In general, in for example a UMTS or similar wireless systems, wireless devices, such as UEs, perform measurements for, for example, determining link quality in the radio network, and then send the results to the network in the form of UE measurement reports. These measurement reports provide information that is used by the network for dynamic network planning and the distribution of resources at the radio interface. In broad terms and in general, a UE measures characteristics including for example the power on downlink physical channels at the same frequency as the active set (intra-frequency measurements), on downlink physical channels at frequencies that differ from the frequency of the active set (inter-frequency measurements), and on downlink physical channels belonging to radio access technologies (RATs) other than the one(s) currently in use (inter-RAT measurements). These measurements are used for example to determine which neighbour cell offers the best radio link quality; a connection may then be set up to this cell. Measurements may be carried out by the UE periodically or when triggered by certain events or both.

As a particular example in the case of UMTS, a relevant technical specification for present purposes is TS 25.331 entitled “Radio Resource Control (RRC); Protocol Specification”, the entire content of which is incorporated herein by reference. The RRC protocol provides a number of services in supporting the radio/air interfaces. In order to manage connectivity in UMTS, the UTRAN (Universal Mobile Telecommunications System Terrestrial Radio Access Network) requires a UE to perform various measurements in relation to cells, and to report measurement results back to the UTRAN. This is required for various aspects of radio resource management in the UTRAN, such as to define and/or modify the set of active cells to which a UE should have a radio link. A list of RRC services is set out in Section 5.1 of TS 25.331 referenced above and includes for example “UE measurement reporting and control of the reporting”. The UTRAN may control a measurement in the UE either by broadcast of system information and/or by transmitting a MEASUREMENT CONTROL message to the UE. A MEASUREMENT CONTROL message may be used to set up, modify or terminate a measurement by the UE. The MEASUREMENT CONTROL message may include data including one or more of (i) measurement type, (ii) measurement objects (e.g. cells to be measured), and (iii) measurement reporting criteria, in particular whether reporting should be periodical or event-triggered.

In general, a UE performs measurements in relation to cells that fall into three categories, namely active set cells, monitored set cells and detected set cells, these being mutually exclusive. The active set cells are a cell or cells that are currently communicating with the UE in supporting a connection and known to the network. In UMTS, these cells are included by the UTRAN in a variable called “CELL_INFO_LIST”. The monitored set cells are non-active set cells that are nevertheless known to the network. In UMTS, these cells are also included by the UTRAN in the CELL_INFO_LIST. The detected set cells are cells that are detected by the UE but which are not known to the network. In UMTS, these cells are neither in the CELL_INFO_LIST nor in the active set. Measurements for detected set cells may be used by the UTRAN in for example configuring neighbour cell lists. Detected cells can be added to the CELL_INFO_LIST, and to the active set cells, for subsequent monitoring, and will therefore become monitored or active set cells respectively in that case.

In event-triggered reporting, the UTRAN may instruct the UE to make intra-frequency measurements of a specified kind by setting a value in an information element (IE) “Intra-frequency measurement quantity”, this IE being sent in a MEASUREMENT CONTROL message. The value that is set specifies the measurement that the UE will use in recognising an event. The measurements are generally intended to support continuous communication with the UE as conditions for the UE change, such as may occur because of movement of the UE or a drop in performance of a network access point. Event-triggered intra-frequency reports may cover for example any one or more of pathloss (PL), received signal code power (RSCP), and the ratio of the received energy per chip (i.e. code bit) and the interference level (Ec/Io). Corresponding IEs for inter-frequency measurements and for inter-RAT measurements may be used in a MEASUREMENT CONTROL message that is sent by the UTRAN to the UE for inter-frequency measurements and for inter-RAT measurements respectively.

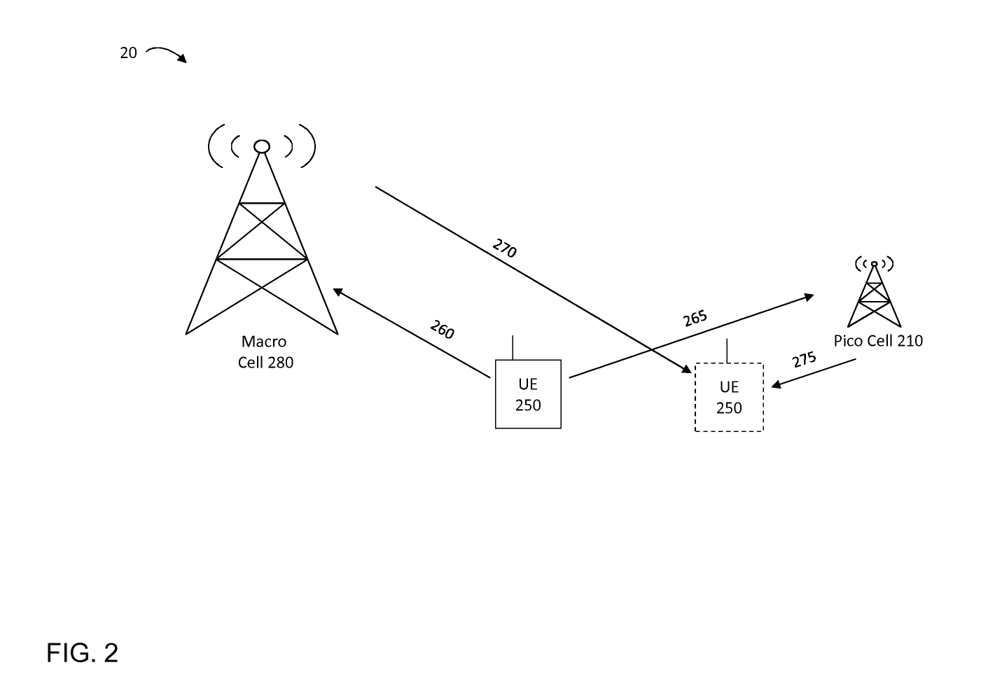

A cellular telecommunications network 20 according to embodiments will now be described with reference to FIG. 2.

Cellular telecommunications network 20 comprises a heterogeneous network where a macro cell 280 comprises a relatively high power node (HPN), and pico cell 210 comprises a relatively low power node (LPN) with UL and/or DL coverage at least partially overlapping with the HPN. Network 20 of FIG. 2 may also comprise one or more network control nodes such as RNCs (not shown). In the example network depicted in FIG. 2, the LPN comprises a pico cell, but, alternatively or in addition, may equally comprise another type of LPN such as a micro or femto cell. The HPN of FIG. 2 may use at least one carrier frequency which is the same as at least one carrier frequency of the LPN, i.e. the network may comprise a co-channel heterogeneous network.

FIG. 2 depicts a situation where an UL/DL imbalance occurs due to transmit power difference between a LPN and a HPN. In particular, FIG. 2 depicts a situation where there is a deviation between an optimal DL multiflow (MF) zone or DL soft handover (SHO) zone and an optimal UL SHO zone, the reasons for which will be explained in the following. The term soft handover (SHO) refers to a handover in which a source cell channel is maintained for a while in parallel with a target cell channel, i.e. a connection to a target cell is established before the connection to a source cell is broken.

In the embodiments of FIG. 2, cellular telecommunication network 20 is a HetNet which comprises a macro (serving) cell 280 that is currently serving a UE 250 and a neighbouring pico cell 210 that is a neighbour of macro cell 280. Macro cell 280 comprises a relatively high power node (HPN) compared to pico cell 210 which comprises a relatively low power node (LPN) with uplink and/or downlink coverage at least partially overlapping with macro cell 280. In practice, cellular telecommunication network 20 could contain more neighbouring and/or overlapping cells (for example macro, micro, pico, or femto cells) which are not depicted in FIG. 2.

User equipment 250 is able to communicate with macro cell 280 or pico cell 210 via one or more wireless communication channels. A first instance of UE 250, depicted with a solid line outline, has an UL channel 260 to macro cell 280 and an UL channel 265 to pico cell 210. A further instance of UE 250, depicted with a dashed line outline, has a DL channel 270 from macro cell 280 and a DL channel 275 from pico cell 210. Note that two instances of UE 250 are depicted in FIG. 2 for explanatory purposes only; in reality, there would only be a single instance of UE 250. In particular, the two instances of UE 250 (solid and dashed line) are used to depict an optimal ULSHO zone and an optimal DL SHO or DL multiflow (MF) zone respectively.

Separate measurement reports, for example for Events 1A/B (where a primary CPICH enters/leaves the reporting range respectively) associated with different measurement control configurations may be required to trigger MF and UL SHO respectively. On the other hand, in equations for triggering event 1A/B in existing specification 3GPP TS 25.331, Cell Individual Offset (CIO) is a cell specific value (or ‘parameter’) which has been used in measurement events related to cell selection, DL MF and UL SHO. This means that event 1A/B would share the same CIO regardless of the purpose for the DL MF or UL SHO, causing suboptimal operation of the system and performance degradation.

The equation used for event 1A as described in section 14.1.2 of 3GPP TS 25.331 is as follows:

$$10 \cdot Log {M}_{New} + {CIO}_{New} \geq W \cdot 10 \cdot Log ( {\sum }_{i = 1}^{{N}_{A}} {M}_{i} ) + ( 1 - W ) \cdot 10 \cdot Log {M}_{Best} - ( {R}_{1 a} - {H}_{1 a} / 2 ) , \qquad ( 1 )$$

The parameters in equation (1) are defined as follows:
M_{New} is the measurement result of the cell entering the reporting range.
CIO_{New} is the individual cell offset for the cell entering the reporting range if an individual cell offset is stored for that cell. Otherwise it is equal to 0.
Mᵢ is a measurement result of a cell not forbidden to affect reporting range in the active set.
N_{A} is the number of cells not forbidden to affect reporting range in the current active set.
M_{Best} is the measurement result of the cell not forbidden to affect reporting range in the active set with the highest measurement result, not taking into account any cell individual offset.
W is a parameter sent from UTRAN to UE.
R₁ₐ is the reporting range constant.
H₁ₐ is the hysteresis parameter for the event 1 a.

Here, the measurement result for M_{New}, Mᵢ and M_{Best} is CPICH-RSCP.

Returning to the embodiments depicted in FIG. 2, say macro cell 280 has a transmit power of 43 dBm, pico cell 210 has a transmit power of 30 dBm, UL 260 has an X dB pathloss (PL), UL 265 has an X dB PL, DL 270 has a Y+13 dB PL, and DL 275 has a Y dB PL. This leads to an optimal UL SHO zone with similar PL for UE 250 (solid line) having a CIO value of between 8 and 13 dB. However, this also leads to an optimal DL SHO or DL MF zone with similar received power for UE 250 (dashed line) having a CIO value of between 0 and 3 dB.

In other words, when applying equation (1) for deciding on DL SHO/MF or UL SHO as illustrated in FIG. 2, CIO_{New} can be only optimized for one of these cases and would deviate the other one from the optimal operation. From a DL MF or DL SHO perspective, the optimal CIO_{New} would be set less than 3 dB. However, from an UL SHO perspective, the optimal CIO_{New} should be set to be more than 8 dB when taking into account the effect of the transmit power difference on the measured CPICH-RSCPs. Moreover, optimization of CIO_{New} for one purpose is not easy since it is also commonly in use for the events which trigger cell selection.

Embodiments introduce use of multiple CIO values which can be used and optimised independently of each other. To optimize the UL SHO and DL MF respectively, a specific CIO value for each is used in embodiments instead of a common CIO value for Event 1A/1B reporting.

Thus, according to embodiments, one more CIO value in addition to the existing CIO value is introduced as follows:

Secondary CIO (S_CIO): used for triggering optimal UL SHO reception in the network. It would generally not be used for cell reselection, DL MF or DL SHO.

Further, considering the potential optimization for DL MF and cell reselection/serving cell change respectively, according to embodiments, another CIO value is introduced as follows:

Third CIO (T_CIO): used to optimize DL MF/SHO operation, whereas the legacy CIO value is used for cell selection and serving cell change.

Embodiments comprise updates to the network signalling required to support the multiple CIOs for different measurement reports.

Applying different CIOs for DL and UL SHO according to embodiments, means that the active sets (of cells) for each can contain one or more different cells. This also means that conditions for downlink control channels, for example a control channel of an enhanced dedicated channel (E-DCH) cell, may not be optimal for all radio links that are in the UL active set. Hence, there may be a need to increase downlink control channel transmission power in one or more cells according to embodiments. Additional signalling for power offsets could be applied between a network controller node such as an RNC and a network access node such as a node B.

For example, when a UE uses a non-legacy CIO value (for example, the secondary CIO value S_CIO) to only trigger SHO without change of a serving cell (for example a HS-DSCH cell or an enhanced dedicated channel (E-DCH) cell) in the HetNet case, the downlink quality from the serving cell may deteriorate because the secondary CIO would bias the UE away from the dominant area of the serving cell. Therefore, according to embodiments, to ensure the UE can still receive control information from the serving cell correctly, the transmission power of a downlink control channel in the serving cell of the UE is increased. This may for example involve boosting the power of a HS-SCCH channel in a serving HS-DSCH cell.

In such a case, it may be necessary to improve the reception for the UE which triggered the secondary CIO value. Therefore, according to embodiments, a larger power offset between a control channel and a common pilot channel in at least one serving cell of the UE is configured. This may for example involve configuring a larger power offset between a HS-SCCH channel and a P-CPICH in a serving cell of the UE. In embodiments, the larger power offset is derived at least on the basis of a power imbalance level between the at least one serving cell of the UE and at least one other cell in the network. The configuration update may be implemented for example by a network controller node such as an RNC instructing a network access node such as a node B with one or more appropriate configuration change/update commands.

Further, embodiments comprise increasing downlink control channel transmission power. The additional signalling for power offsets could be applied between a network controller node such as an RNC and a network basestation node such as a node B.

In first embodiments, the measurement event configuration determines which CIO value will be applied. In second embodiments, measurement events are evaluated using all possible CIO values and the measurement report indicates to a network controller node such as an RNC which CIO value or values (possibly more than one) were used in relation to the measurement report.

For both first and second embodiments, multiple CIO values are added into the IE “Cell info” included in the IE “intra frequency cell info list”. A network controller node such as an RNC would send the signalling to inform the UE of the intra frequency cell list and the associated multiple CIO values per cell.

Embodiments comprise measures, including methods, apparatus and computer program products, for use in measurement reporting in a cellular telecommunications network. One or more configuration parameters for configuring a plurality of Cell Individual Offset (CIO) values for use in measurement reporting in a given cell are generated. Signalling information comprising the generated configuration parameters for the plurality of CIO values is transmitted to at least one user equipment in the given cell.

Embodiments improve the overall system performance with separate optimization for DL SHO/MF, UL SHO and cell selection cases. Embodiments can be implemented at a low signalling cost. Embodiments address specific problems encountered in a HetNet scenario.

Embodiments comprise, at the at least one user equipment in the given cell, receiving signalling information comprising the one or more configuration parameters for configuring a plurality of Cell Individual Offset (CIO) values for use in measurement reporting in the given cell, the configuration parameters having been generated in and received from the network.

In embodiments, the plurality of CIO values comprises a first CIO value associated with cell selection and/or serving cell change and at least one of a second CIO value associated with uplink soft handover, and a third CIO value associated with downlink soft hand over and/or downlink multiflow operation. In these embodiments, either two or three CIO values are employed.

In embodiments, the plurality of CIO values comprises a first CIO value associated with cell selection and/or serving cell change, a second CIO value associated with uplink soft hand over, and a third CIO value associated with downlink soft hand over and/or downlink multiflow operation. In these embodiments, three CIO values are employed.

According to embodiments, the second CIO value associated with UL SHO takes into account the transmission power difference between the HPN and the LPN, which in the example case of FIG. 2 comprise macro cell 280 and pico cell 210 respectively.

According to embodiments, the third CIO value associated with downlink DL SHO and/or DL MF operation takes into account the received power difference between HPN and the LPN, which in the example case of FIG. 2 comprise macro cell 280 and pico cell 210 respectively.

In embodiments, the signalling information transmitted to the at least one user equipment is comprised in a cell info information element.

According to embodiments, the transmitted signalling information comprises an intra frequency cell info list, the generation comprises generating configuration parameters for a plurality of CIO values for a plurality of cells in the intra frequency cell info list, and the transmitted signalling information comprises the generated configuration parameters for the plurality of CIO values for the plurality of cells in the intra frequency cell info list.

In embodiments, one or more of the HPN and the LPN are comprised in the active set of cells for UE 250, for example dedicated channel (DCH) active set cells.

In embodiments, one or more of the HPN and the LPN are comprised in the set of the serving downlink shared channel cell and an assisting serving downlink shared channel cell for UE 250, for example a HS-DSCH serving cell and an assisting HS-DSCH serving cell, i.e. in the case of MF serving cells.

In first embodiments, for the IE “Intra-frequency measurement reporting criteria” included in a measurement control message, the IE “CIO_indicator” is added to indicate which CIO value should be used by the UE for triggering the measurement report in case of Event 1A/1B reporting. For example:

CIO_Indicator=“CIO”, the ‘legacy’ (i.e. already existing) or ‘primary’ CIO value would be optimized for triggering cell selection or the serving cell change.

CIO_Indicator=“S_CIO”, a ‘secondary’ CIO value which is used for triggering the optimal UL SHO taking into account the transmission power difference.

CIO_Indicator=“T_CIO”, a ‘tertiary’ CIO value which is used for triggering the optimal DL SHO or MF taking into account the received power difference.

In first embodiments, for each measurement (especially for event 1A/B), a network controller node such as a RNC would send a measurement control message to the UE to configure the reporting criteria in which the CIO type (e.g. legacy, secondary or tertiary) to be used would be indicated.

In first embodiments, legacy UEs, i.e. those which do not support use of multiple CIO values, only use “CIO” for measurement evaluation. Newer release UEs, i.e. those which do support use of multiple CIO values, make the evaluation based on the corresponding CIO value(s) indicated in the measurement control message. Accordingly, an appropriate measurement report would be sent from the UE into the network if the relevant reporting criteria are fulfilled.

First embodiments may comprise transmitting, to the to at least one user equipment, a measurement control message comprising one or more reporting criteria to be used by the at least one user equipment in relation to triggering transmittal of a measurement report of a first type into the network. In such embodiments, the one or more reporting criteria comprise an indication of which CIO value in the plurality of CIO values should be used by the at least one user equipment in relation to triggering transmittal of the first type of measurement report.

First embodiments may comprise, in response to the one or more reporting criteria including the indicated CIO value being met, triggering transmittal of a measurement report of the first type into the network.

First embodiments may comprise receiving a measurement report of the first type from the at least one user equipment. The indication of which CIO value in the plurality of CIO values should be used by the at least one user equipment in relation to triggering transmittal of the first type of measurement report may be comprised in an intra frequency measurement reporting criteria information element in the measurement control message. The measurement report of the first type may be associated with occurrence of a cell entering a reporting range event (for example Event 1A) or with occurrence of a cell leaving a reporting range event (for example Event 1B).

In second embodiments, no modifications are made to measurement control messages, i.e. measurement control messages are used in the legacy manner.

In second embodiments, legacy UEs only use “CIO” for measurement evaluation. Newer release UEs, make the evaluation based on at least two and possibly three (or even more) CIO values, for example as provided in the “cell info” IE provided by the network. In second embodiments, newer release UEs provide an indication of which CIO value(s) caused the event to trigger in the measurement report; this indication may for example comprise the addition of three new Boolean IE to a “Measurement Report” IE as follows:

CIO_Triggered_Report=TRUE indicates that the legacy CIO value caused the event to trigger, else the event was not triggered by the legacy CIO value.

S_CIO_Triggered_Report=TRUE indicates that the S_CIO value caused the event to trigger, else the event was not triggered by the S_CIO value.

T_CIO_Triggered_Report=TRUE indicates that the T_CIO value caused the event to trigger, else the event was not triggered by the T_CIO value.

In second embodiments, upon occurrence of the requisite event reporting criteria, including an associated CIO value (or values), being detected by the UE, the UE transmits a measurement report of a second type into the network. The transmitted measurement report of the second type comprises an indication of which CIO value in the plurality of CIO values caused triggering of transmittal of the measurement report of the second type from the UE.

Second embodiments may comprise receiving a measurement report of a second type from the at least one user equipment. In such embodiments, the received measurement report of the second type comprises an indication of which CIO value in the plurality of CIO values caused triggering of transmittal of the measurement report of the second type from the at least one user equipment. The measurement report of the second type may for example be associated with occurrence of a cell entering a reporting range event (for example Event 1A), with occurrence of a cell leaving a reporting range event (for example Event 1B), and/or with occurrence of a cell replacement between an active set cell and a monitored set cell event (for example Event 1C).

The indication in the received measurement report of the second type may comprise a Boolean information element set to a true value, the Boolean information element being specific to the CIO value which caused triggering of transmittal of the measurement report of the second type from the at least one user equipment.

The indication in the received measurement report of the second type may comprise one or more further Boolean information elements set to false values, the one or more further Boolean information elements being specific to one or more further respective CIO values in the plurality of CIO values other than the CIO value which caused triggering of transmittal of the measurement report of the second type from the at least one user equipment.

The indication in the received measurement report of the second type may comprise an enumerated (true) information element, the enumerated (true) information element being specific to the CIO value which caused triggering of transmittal of the measurement report of the second type from the at least one user equipment. In embodiments, presence of the information element means true and absence of the information element means false (or alternatively, presence of an enumerated (false) information element).

The second embodiments described above provide efficiencies in relation to signalling overhead in the measurement configuration because the second embodiments avoid the need to configure multiple events, if a network controller node such as an RNC wishes to use similar events for UL and/or DL active set updates.

The first embodiments described above provide efficiencies in relation to configuration flexibility, for example since other parameters such as reporting range can be configured independently for the uplink and downlink events.

In the first embodiments, the same reporting criterion is associated with one assigned CIO, whereas in the second embodiments, one reporting criterion is associated with multiple CIOs but the CIO triggering the report is indicated in the measurement report by a UE.

Alternative embodiments for use in measurement reporting in a cellular telecommunications network, comprise measures, including methods, apparatus and computer program products, for transmitting, to at least one user equipment in a given cell, a measurement control message comprising one or more reporting criteria to be used by the at least one user equipment in relation to triggering transmittal of a measurement report into the network, wherein the one or more reporting criteria comprise an indication of which Cell Individual Offset (CIO) value of a plurality of CIO values should be used by the at least one user equipment in relation to triggering transmittal of the measurement report. Other alternative embodiments comprise measures, including methods, apparatus and computer program products, for use in measurement reporting in a cellular telecommunications network, the method comprising receiving a measurement report from at least one user equipment in a given cell, wherein the received measurement report comprises an indication of which Cell Individual Offset (CIO) value of a plurality of CIO values caused triggering of transmittal of the measurement report from the at least one user equipment. Such alternative embodiments enable use of multiple CIOs in a network without requiring generation of configuration parameters for configuring a plurality of CIO values for use in measurement reporting in a given cell nor transmitting such to a UE in signalling information as per other embodiments described above. Note that such generation and transmittal features may be combined with such alternative embodiments in yet more alternative embodiments. The CIOs for these alternative embodiments may comprise any of the first CIO value associated with cell selection and/or serving cell change, the second CIO value associated with uplink soft handover, and the third CIO value associated with downlink soft handover and/or downlink multiflow operation described herein in relation to other embodiments.

Further alternative embodiments for use in measurement reporting in a cellular telecommunications network, comprise measures, including methods, apparatus and computer program products, for receiving a measurement report from at least one user equipment in a given cell, wherein the received measurement report comprises an indication of which Cell Individual Offset (CIO) value of a plurality of CIO values caused triggering of transmittal of the measurement report from the at least one user equipment. Other further alternative embodiments comprise measures, including methods, apparatus and computer program products, for use in measurement reporting in a cellular telecommunications network, the method comprising, at a user equipment in a given cell, transmitting a measurement report into the network, wherein the transmitted measurement report comprises an indication of which Cell Individual Offset (CIO) value of a plurality of CIO values caused triggering of transmittal of the measurement report from the user equipment. Such further alternative embodiments enable use of multiple CIOs in a network without requiring generation of configuration parameters for configuring a plurality of CIO values for use in measurement reporting in a given cell nor transmitting such to a UE in signalling information as per other embodiments described above. Note that such generation and transmittal features may be combined with such further alternative embodiments in yet more further alternative embodiments. The CIOs for these further alternative embodiments may comprise any of the first CIO value associated with cell selection and/or serving cell change, the second CIO value associated with uplink soft handover, and the third CIO value associated with downlink soft handover and/or downlink multiflow operation described herein in relation to other embodiments.

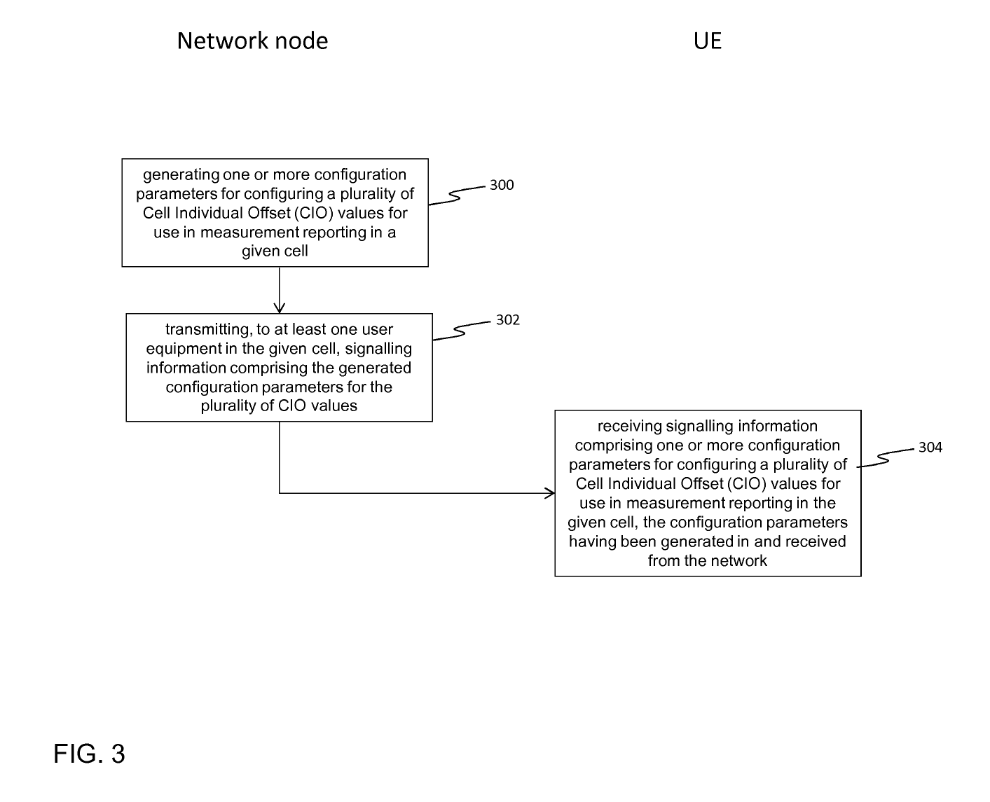

FIG. 3 shows a flow diagram according to embodiments. In particular, FIG. 3 depicts measures for use in measurement reporting in a cellular telecommunications network. More specifically, items 300 and 302 cover embodiments from the perspective of one or more network nodes and item 304 covers embodiments from the perspective of at least one user equipment.

Item 300 involves generating one or more configuration parameters for configuring a plurality of Cell Individual Offset (CIO) values for use in measurement reporting in a given cell.

Item 302 involves transmitting, to at least one user equipment in the given cell, signalling information comprising the generated configuration parameters for the plurality of CIO values.

Item 304 involves receiving signalling information comprising one or more configuration parameters for configuring a plurality of CIO values for use in measurement reporting in the given cell, the configuration parameters having been generated in and received from the network.

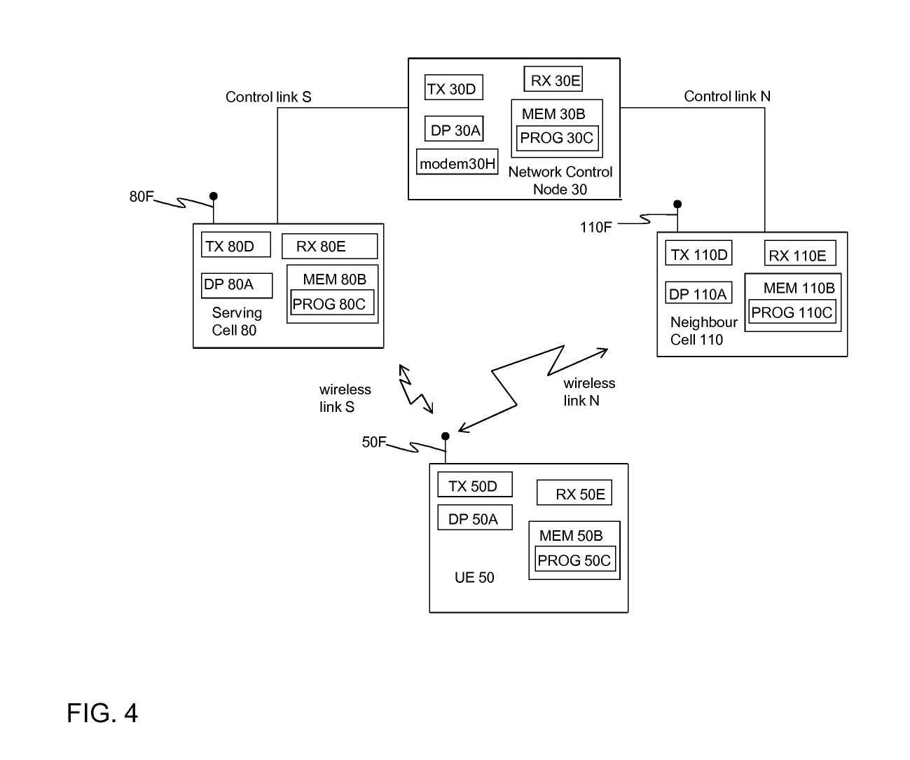

Reference is now made to FIG. 4 for illustrating a simplified block diagram of various electronic devices and apparatus that are suitable for use in practising embodiments of the present invention. In FIG. 4, serving cell 80 is adapted for communication over a wireless link S with a UE 50, such as a mobile terminal. Similarly, a neighbour cell 110 is adapted for communication over a wireless link N with UE 50. Serving cell 80 and/or neighbour cell 110 each may comprise a macro Node B, an eNodeB, a remote radio head, relay station, a femto cell or home NodeB, or other type of base station/cellular network access node.

UE 50 may include processing means such as a processing system and/or at least one data processor (DP) 50A, storing means such as at least one computer-readable memory (MEM) 50B storing at least one computer program (PROG) 50C, and also communicating means such as a transmitter TX 50D and a receiver RX 50E for bidirectional wireless communications with the serving cell 80 and/or neighbour cell 110 and/or any other neighbouring cells (not shown) via one or more antennas 50F. Note that embodiments may be carried out by apparatus such as a modem that does not comprise an antenna.

Serving cell 80 includes its own processing means such as a processing system and/or at least one data processor (DP) 80A, storing means such as at least one computer-readable memory (MEM) 80B storing at least one computer program (PROG) 80C, and communicating means such as a transmitter TX 80D and a receiver RX 80E for bidirectional wireless communications with other devices under its control via one or more antennas 80F. There is a data and/or control path, termed at FIG. 4 as a control link S which in the 3GPP cellular system may be implemented as an Iub interface or in E-UTRAN as an S1 interface, coupling the serving cell 80 with network entity 30, and over which the network entity 30 and the serving cell 80 may exchange control messages, such as system information update requests and/or change notifications. Network control node 30 may for example comprise an RNC, MME or suchlike.

Similarly, neighbour cell 110 includes its own processing means such as a processing system and/or at least one data processor (DP) 110A, storing means such as at least one computer-readable memory (MEM) 110B storing at least one computer program (PROG) 110C, and communicating means such as a transmitter TX 110D and a receiver RX 110E for bidirectional wireless communications with other devices under its control via one or more antennas 110F. There is a data and/or control path, termed at FIG. 4 as a control link N which in the 3GPP cellular system may be implemented as an Iub interface or in E-UTRAN as an S1 interface, coupling the neighbour cell 110 with network entity 30, and over which network entity 30 and the neighbour cell 110 may exchange control messages, such as system information update requests and/or change notifications.

Network control node 30 includes processing means such as a processing system and/or at least one data processor (DP) 30A, storing means such as at least one computer-readable memory (MEM) 30B storing at least one computer program (PROG) 30C, and communicating means such as a modem 30H for bidirectional communication with serving cell 80 over control link S or with neighbour cell 110 over control link N.

While not particularly illustrated for UE 50, serving cell 80, neighbour cell 110 and network control node 30, those devices are also assumed to include as part of their wireless communicating means a modem which may be inbuilt on a RF front end chip within those devices 50, 80, 110 30 and which chip also carries the TX 50D/80D/110D/30D and the RX 50E/80E/110E/30E.

Various embodiments of UE 50 can comprise various different wireless devices including in general any device capable of connecting wirelessly to a network, and includes in particular mobile devices including mobile or cell phones (including so-called “smart phones”), personal digital assistants, pagers, tablet, phablet and laptop computers, content-consumption or generation devices (for music and/or video for example), data cards, USB dongles, etc., as well as fixed or more static devices, such as personal computers, game consoles and other generally static entertainment devices, various other domestic and non-domestic machines and devices, etc. A UE may also be referred to as a user station, mobile station or endpoint device.

At least one of the PROGs 50C in UE 50 is assumed to include program instructions that, when executed by the associated DP 50A, enable the device to operate in accordance with embodiments of the present invention, as detailed above. Serving cell 80, neighbour cell 110 and network control node 30 also have software stored in their respective MEMs to implement certain aspects of these teachings. In these regards, embodiments may be implemented at least in part by computer software stored on the MEM 50B, 80B, 110B, 30B which is executable by the DP 50A of UE 50, DP 80A of serving cell 80, DP 110A of neighbour cell 110 and/or DP 30A of network entity 30, or by hardware, or by a combination of tangibly stored software and hardware (and tangibly stored firmware). Electronic devices implementing these aspects of the invention need not be the entire devices as depicted at FIG. 4, but embodiments may be implemented by one or more components of same such as the above described tangibly stored software, hardware, firmware and DP, or a system on a chip SOC, an application specific integrated circuit ASIC or a digital signal processor DSP.

Various embodiments of the computer readable MEMs 50B, 80B, 110B and 30B include any data storage technology type which is suitable to the local technical environment, including but not limited to semiconductor based memory devices, magnetic memory devices and systems, optical memory devices and systems, fixed memory, removable memory, disc memory, flash memory, DRAM, SRAM, EEPROM and the like. Various embodiments of the DPs 50A, 30A, 110A and 80A include but are not limited to general purpose computers, special purpose computers, microprocessors, digital signal processors (DSPs) and multi-core processors.

Reference will sometimes be made in this specification to “network”, “network control apparatus” (or “network control node”) and “base station”. In this respect, it will be understood that the “network control apparatus” is the overall apparatus that provides for general management and control of the network and connected devices. Such apparatus may in practice be constituted by several discrete pieces of equipment. As a particular example in the context of UMTS (Universal Mobile Telecommunications System), the network control apparatus may be constituted by for example a so-called Radio Network Controller operating in conjunction with one or more Node Bs (which, in many respects, can be regarded as “base stations”). As another example, LTE (Long Term Evolution) makes use of a so-called evolved Node B (eNB) where the RF transceiver and resource management/control functions are combined into a single entity. The term “base station” is used in this specification to include a “traditional” base station, a Node B, an evolved Node B (eNB), or any other access point to a network, unless the context requires otherwise. Moreover for convenience and by convention, the terms “network”, “network control apparatus” and “base station” will often be used interchangeably, depending on the context.

Although at least some aspects of the embodiments described herein with reference to the drawings comprise computer processes performed in processing systems or processors, the invention also extends to computer programs, particularly computer programs on or in a carrier, adapted for putting the invention into practice. The program may be in the form of non-transitory source code, object code, a code intermediate source and object code such as in partially compiled form, or in any other non-transitory form suitable for use in the implementation of processes according to the invention. The carrier may be any entity or device capable of carrying the program. For example, the carrier may comprise a storage medium, such as a solid-state drive (SSD) or other semiconductor-based RAM; a ROM, for example a CD ROM or a semiconductor ROM; a magnetic recording medium, for example a floppy disk or hard disk; optical memory devices in general; etc.

It will be understood that the processor or processing system or circuitry referred to herein may in practice be provided by a single chip or integrated circuit or plural chips or integrated circuits, optionally provided as a chipset, an application-specific integrated circuit (ASIC), field-programmable gate array (FPGA), digital signal processor (DSP), etc. The chip or chips may comprise circuitry (as well as possibly firmware) for embodying at least one or more of a data processor or processors, a digital signal processor or processors, baseband circuitry and radio frequency circuitry, which are configurable so as to operate in accordance with the exemplary embodiments. In this regard, the exemplary embodiments may be implemented at least in part by computer software stored in (non-transitory) memory and executable by the processor, or by hardware, or by a combination of tangibly stored software and hardware (and tangibly stored firmware).

The above embodiments are to be understood as illustrative examples of the invention. Further embodiments of the invention are envisaged.

Reference is made to first embodiments above. It should be understood that not all features described in relation to any of the first embodiments are required, i.e. any features of any of the first embodiments may be omitted from embodiments.

Similarly, reference is made to second embodiments above and it should be understood that not all features described in relation to any of the second embodiments are required, i.e. any features of any of the second embodiments may be omitted from embodiments.

Any features from the first embodiments described above may be applied alternatively or in addition, in any combination, to any features from the second embodiments or any other embodiments described above.

Any steps carried out on a network side (as opposed to on a user equipment side) of any embodiments described herein may be carried out by one or more network control nodes such as RNCs or one or more basestation network nodes such as eNBs, or any combination thereof, i.e. some embodiments may involve some steps being carried out by one or more network control nodes and other steps being carried out by one or more basestation network nodes.

Any transfer of signalling information, configuration parameters, etc. described herein in relation to embodiments may for example be transferred via RRC signalling.

It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

### LIST OF ABBREVIATIONS AND ACRONYMS

3GPP Third Generation Partnership Project
CPICH common pilot channel
DL downlink
E-DCH enhanced dedicated channel
eNB evolved Node B
EUTRAN Evolved Universal Terrestrial Radio Access Network
HetNet heterogeneous network
HPN high power node
HS-DPCCH high speed dedicated physical control channel
HSDPA high speed downlink packet access
HS-DSCH high speed downlink shared channel
HSPA high speed packet access
IE information element
LPN low power node
LTE Long Term Evolution
LTE-A Long Term Evolution Advanced
MME mobility management entity
NW network
PL pathloss
RAT radio access technology
RNC radio network controller
RSCP received signal code power
SHO soft handover
TS technical specification
UE user equipment
UL uplink
UMTS Universal Mobile Telecommunications Service
UTRAN UMTS Terrestrial Radio Access Network

1. A method for use in measurement reporting in a cellular telecommunications network, the method comprising:
generating one or more configuration parameters for configuring a plurality of Cell Individual Offset (CIO) values for use in measurement reporting in a given cell; and
transmitting, to at least one user equipment in said given cell, signalling information comprising said generated configuration parameters for said plurality of CIO values.

2-22. (canceled)

23. An apparatus for use in measurement reporting in a cellular telecommunications network, the apparatus comprising a processing system that comprises at least one data processor and at least one computer-readable memory storing a computer program, wherein the processing system is configured to:
generate one or more configuration parameters for configuring a plurality of Cell Individual Offset (CIO) values for use in measurement reporting in a given cell; and
transmit, to at least one user equipment in said given cell, signalling information comprising said generated configuration parameters for said plurality of CIO values.

24. The apparatus according to claim 23, wherein said plurality of CIO values comprises a first CIO value associated with cell selection and/or serving cell change and at least one of:
a second CIO value associated with uplink soft handover, and
a third CIO value associated with downlink soft handover and/or downlink multiflow operation.

25-26. (canceled)

27. The apparatus according to claim 23, the processing system being configured to transmit, to said to at least one user equipment, a measurement control message comprising one or more reporting criteria to be used by said at least one user equipment in relation to triggering transmittal of a measurement report of a first type into said network,
wherein said one or more reporting criteria comprise an indication of which CIO value in said plurality of CIO values should be used by said at least one user equipment in relation to triggering transmittal of said first type of measurement report.

28-29. (canceled)

30. The apparatus according to claim 23, wherein the processing system being configured to receive a measurement report of a second type from said at least one user equipment,
wherein said received measurement report of said second type comprises an indication of which CIO value in said plurality of CIO values caused triggering of transmittal of said measurement report of said second type from said at least one user equipment,
wherein said indication in said received measurement of said second type comprises a Boolean information element set to a true value, said Boolean information element being specific to said CIO value which caused triggering of transmittal of said measurement report of said second type from said at least one user equipment,
wherein said indication in the received measurement report of said second type comprises one or more further Boolean information elements set to false values, said one or more further Boolean information elements being specific to one or more further respective CIO values in said plurality of CIO values other than said CIO value which caused triggering of transmittal of said measurement report of said second type from said at least one user equipment.

31-32. (canceled)

33. The apparatus according to claim 23, wherein said received measurement report of said second type comprises an indication of which CIO value in said plurality of CIO values caused triggering of transmittal of said measurement report of said second type from said at least one user equipment, and wherein said indication in said received measurement report of said second type comprises an enumerated (true) information element, said enumerated (true) information element being specific to said CIO value which caused triggering of transmittal of said measurement report of said second type from said at least one user equipment.

34. (canceled)

35. The apparatus according to claim 23, wherein:
said cellular telecommunications network comprises a heterogeneous network,
at least one cell in said heterogeneous network comprises a relatively high power node, and
at least one other cell in said heterogeneous network comprises a relatively low power node with uplink and/or downlink coverage at least partially overlapping with said relatively high power node,
wherein said relatively high power node comprises a macro cell and said relatively low power node comprises a micro, pico or femto cell, and
wherein said relatively high power node uses at least one carrier frequency which is the same as at least one carrier frequency of the relatively low power node.

36-63. (canceled)

64. An apparatus for use in measurement reporting in a cellular telecommunications network, the apparatus comprising a processing system that comprises at least one data processor and at least one computer-readable memory storing a computer program, wherein the processing system is configured to cause a user equipment in a given cell to:
receive signalling information comprising one or more configuration parameters for configuring a plurality of Cell Individual Offset (CIO) values for use in measurement reporting in said given cell, said configuration parameters having been generated in and received from said network.

65. The apparatus according to claim 64, wherein said plurality of CIO values comprises a first CIO value associated with cell selection and/or serving cell change and at least one of:
a second CIO value associated with uplink soft handover, and
a third CIO value associated with downlink soft handover and/or downlink multiflow operation.

66. (canceled)

67. The apparatus according to claim 64, wherein:
said received signalling information comprises an intra frequency cell info list, and
said generated configuration parameters comprise configuration parameters for a plurality of CIO values for a plurality of cells in said intra frequency cell info list.

68. The apparatus according to claim 64, the processing system being configured to receive a measurement control message comprising one or more reporting criteria to be used by said user equipment in relation to triggering transmittal of a measurement report of a first type into said network,
wherein said one or more reporting criteria comprise an indication of which CIO value in said plurality of CIO values should be used by said user equipment in relation to triggering transmittal of said first type of measurement report,
the processing system being configured to, in response to said one or more reporting criteria including said indicated CIO value being met, trigger transmittal of a measurement report of said first type into said network.

69-70. (canceled)

71. The apparatus according to claim 64, the processing system being configured to transmit a measurement report of a second type into said network,
wherein said received measurement report of said second type comprises an indication of which CIO value in said plurality of CIO values caused triggering of transmittal of said measurement report of said second type from said user equipment.

72. The apparatus according to claim 71, wherein said indication in said received measurement report of said second type comprises a Boolean information element set to a true value, said Boolean information element being specific to said CIO value which caused triggering of transmittal of said measurement report of said second type from said user equipment.

73. The apparatus according to claim 72, wherein said indication in said received measurement report of said second type comprises one or more further Boolean information elements set to false values, said one or more further Boolean information elements being specific to one or more further respective CIO values in said plurality of CIO values other than said CIO value which caused triggering of transmittal of said measurement report of said second type from said user equipment.

74. The apparatus according to claim 71, wherein said indication in said received measurement report of said second type comprises an enumerated (true) information element, said enumerated (true) information element being specific to said CIO value which caused triggering of transmittal of said measurement report of said second type from said at least one user equipment.

75. The apparatus according to claim 64, wherein one or more of said measurement report of said first type and said measurement report of said second type is associated with one or more of the following:
occurrence of a cell entering a reporting range event,
occurrence of a cell leaving a reporting range event, and
occurrence of a cell replacement between an active set cell and a monitored set cell event.

76. The apparatus according to claim 64, wherein:
said cellular telecommunications network comprises a heterogeneous network,
at least one cell in said heterogeneous network comprises a relatively high power node, and
at least one other cell in said heterogeneous network comprises a relatively low power node with uplink and/or downlink coverage at least partially overlapping with said relatively high power node.

77. The apparatus according to claim 76, wherein said relatively high power node comprises a macro cell and said relatively low power node comprises a micro, pico or femto cell, and
wherein said relatively high power node uses at least one carrier frequency which is the same as at least one carrier frequency of the relatively low power node.

78. (canceled)

79. The apparatus according to claim 77, wherein said plurality of CIO values comprises a first CIO value associated with cell selection and/or serving cell change and at least one of:
a second CIO value associated with uplink soft handover, and
a third CIO value associated with downlink soft handover and/or downlink multiflow operation,
and wherein said second CIO value associated with uplink soft hand over takes into account the transmission power difference between said at least one relatively high power node and said at least one relatively low power node in said heterogeneous network.

80. The apparatus according to claim 79, wherein said third CIO value associated with downlink soft hand over and/or downlink multiflow operation takes into account the received power difference between said at least one relatively high power node and said at least one relatively low power node in said heterogeneous network.

81-92. (canceled)
